(19) United States
(12) Patent Application Publication
(10) Pub. No.: US 2025/0015397 A1
(43) Pub. Date: Jan. 9, 2025

(54) METHOD OF MANUFACTURING BATTERY CASE

(71) Applicant: Toyota Jidosha Kabushiki Kaisha, Toyota-shi (JP)

(72) Inventors: Yosuke SHIMURA, Toyota-shi (JP); Yoshiro Obayashi, Toyota-shi (JP); Atsushi Yamanaka, Nagoya-shi (JP); Masashi Chihara, Nagoya-shi (JP); Kazuki Sugie, Miyoshi-shi (JP); Kosuke Yonekawa, Nisshin-shi (JP); Yasuhiro Hirao, Toyota-shi (JP)

(73) Assignee: Toyota Jidosha Kabushiki Kaisha, Toyota-shi (JP)

(21) Appl. No.: 18/750,357

(22) Filed: Jun. 21, 2024

(30) Foreign Application Priority Data
Jul. 4, 2023 (JP) 2023-109791

(51) Int. Cl. H01M 50/103

(52) U.S. Cl. CPC H01M 50/103

(57) ABSTRACT

A method of manufacturing a battery case includes: preparing a tubular body having a first opening end and a second opening end that are respectively located at opposite sides in one direction; closing the first opening end with a first plate member; closing the second opening end with a second plate member; in a state where the first opening end is closed with the first plate member and the second opening end is closed with the second plate member, cutting the tubular body, the first plate member, and the second plate member along a plane parallel to the one direction, to obtain a case body having an opening formed by respective cut edges of the tubular body, the first plate member, and the second plate member; and closing the opening of the case body with the lid portion.

### CROSS REFERENCE TO RELATED APPLICATIONS

This nonprovisional application is based on Japanese Patent Application No. 2023-109791 filed on Jul. 4, 2023 with the Japan Patent Office, the entire contents of which are hereby incorporated by reference.

### BACKGROUND

### Field

The present disclosure relates to a method of manufacturing a battery case.

### Description of the Background Art

Japanese Patent Laying-Open No. 2021-158014 discloses a method of manufacturing a battery case in which a sealing plate is integrally attached to an opening of a case body having a bottomed tubular shape. In this manufacturing method, a blank prepared in advance is subjected to drawing and ironing to form an intermediate product having a bottom portion having an elliptical or oval cross-sectional shape. Then, the intermediate product is further subjected to drawing or ironing a plurality of times to gradually reduce the curvature radii of the four corner portions so that the cross-sectional shape becomes rectangular, and the thickness of the side wall portion forming the corner portion is reduced to form the final product to be the case body portion.

### SUMMARY

In order to further reduce the height of the power storage cell, there is a demand for a battery case in which the dimension in one direction orthogonal to the opening direction of the case body is further increased. However, in the drawing process as disclosed in Japanese Patent Laying-Open No. 2021-158014, it is difficult to form an opening having a longer dimension in the one direction. Therefore, in the conventional battery case manufacturing method, the size of the opening in the one direction is limited.

The present disclosure has been made in view of the above problems, and an object of the present disclosure is to provide a method of manufacturing a battery case in which the degree of freedom of dimensions of an opening formed in a case body in one direction can be increased.

A method of manufacturing a battery case according to the present disclosure is a method of manufacturing a battery case capable of accommodating an electrode assembly, and including: a case body in a bottomed tubular shape having a bottom portion and an opening located opposite to the bottom portion; and a lid portion closing the opening. The manufacturing method includes: preparing a tubular body having a first opening end and a second opening end that are respectively located at opposite sides in one direction; closing the first opening end with a first plate member; closing the second opening end with a second plate member; in a state where the first opening end is closed with the first plate member and the second opening end is closed with the second plate member, cutting the tubular body, the first plate member, and the second plate member along a plane parallel to the one direction, to obtain the case body having the opening formed by respective cut edges of the tubular body, the first plate member, and the second plate member; and sealing the opening of the case body with the lid portion.

According to the above configuration, the tubular body having the first opening end and the second opening end on opposite sides can be prepared without depending on the drawing process. At this time, it is also possible to prepare a tubular body which is relatively long in one direction. By cutting the tubular body, the first plate member, and the second plate member along the plane parallel to the one direction, the case body having a relatively long opening in the one direction can be easily obtained. That is, according to the manufacturing method of the battery case according to the present disclosure, the degree of freedom of the dimension of the opening formed in the case body in the one direction can be increased.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a perspective view showing a power storage cell according to an embodiment of the present disclosure.

FIG. 2 is a cross-sectional view of the power storage cell of FIG. 1 taken along a line II-II.

FIG. 3 is a cross-sectional view of the electrode assembly of FIG. 2 as seen from the direction of arrows III-III.

FIG. 4 is a perspective view showing a power storage cell according to a modified example of the present disclosure.

FIG. 5 is a flowchart showing a method of manufacturing a battery case according to an embodiment of the present disclosure.

FIGS. 6A to 6D are schematic views showing a state from the tubular body preparing step to the cutting step in time series.

FIG. 7 is a schematic view showing a third closing step.

### DESCRIPTION OF THE PREFERRED EMBODIMENTS

Embodiments of the present disclosure will be described with reference to the drawings. In the drawings referred to below, the same or corresponding members are denoted by the same reference numerals.

### [Storage Cell]

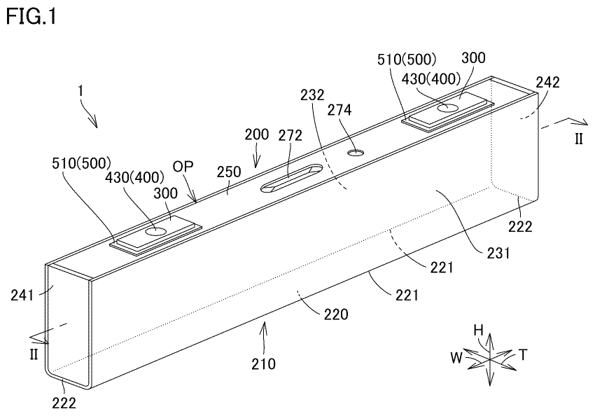

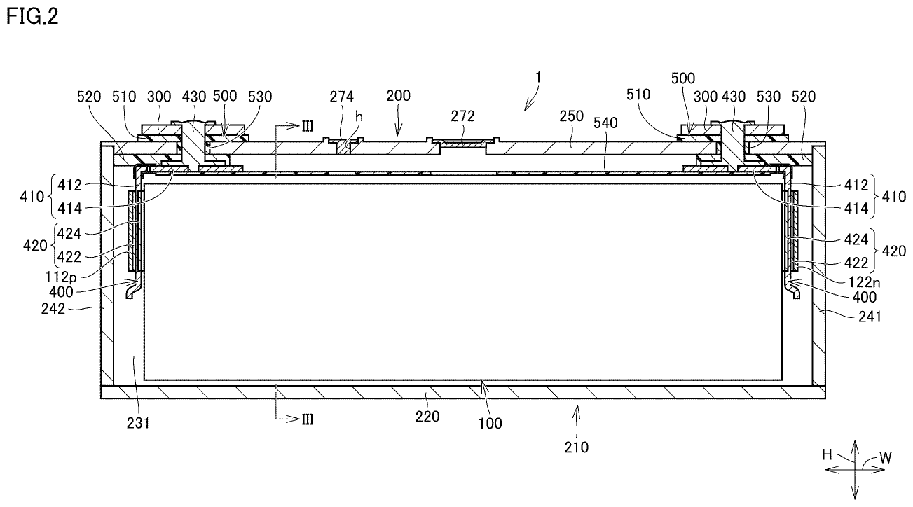

First, a power storage cell according to an embodiment of the present disclosure will be described. The power storage cell includes a battery case manufactured by the manufacturing method of the battery case according to the embodiment of the present disclosure. FIG. 1 is a perspective view showing a power storage cell according to an embodiment of the present disclosure. FIG. 2 is a cross-sectional view of the power storage cell of FIG. 1 taken along a line II-II.

As shown in FIGS. 1 and 2, the power storage cell 1 includes an electrode assembly 100, a battery case 200, a pair of external terminals 300, a pair of connecting members 400, and an insulating member 500.

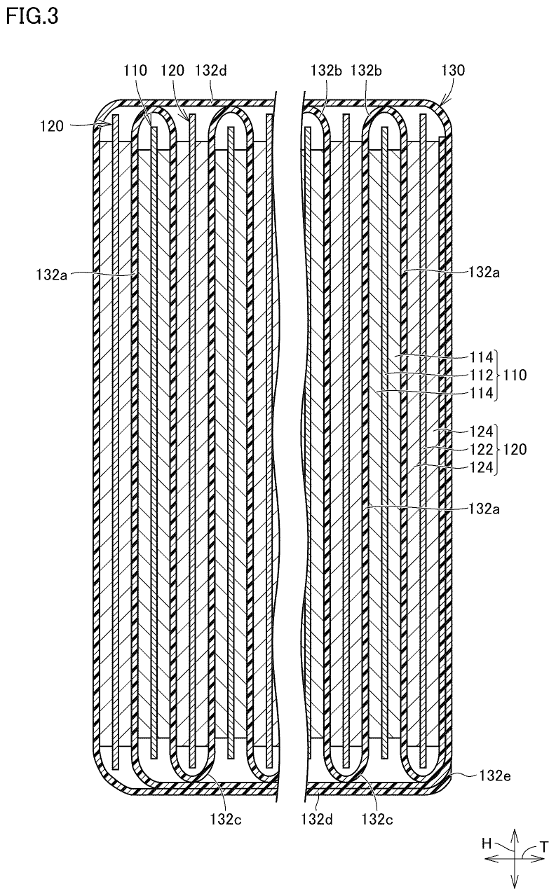

FIG. 3 is a cross-sectional view of the electrode assembly of FIG. 2 as seen from the direction of arrows III-III. As shown in FIG. 3, the electrode assembly 100 includes a plurality of electrodes 110 and 120 and a separator 130.

As shown in FIG. 3, the electrodes 110 and 120 are arranged side by side in the thickness direction T. In this embodiment, the thickness direction T is orthogonal to the height direction H. The plurality of electrodes 110 and 120 have a plurality of positive electrodes 110 and a plurality of negative electrodes 120.

Each positive electrode 110 is formed in a rectangular shape elongated in the width direction W. The width direction W is a direction orthogonal to both the thickness direction T and the height direction H. Each positive electrode 110 includes a positive electrode current collector foil 112 and a positive electrode active material layer 114 provided on both surfaces of the positive electrode current collector foil 112. The positive electrode current collector foil 112 has a positive electrode tab 112p (see FIG. 2) in which the positive electrode active material layer 114 is not provided. The positive electrode tab 112p protrudes toward one side in the width direction W.

Each negative electrode 120 is formed in a rectangular shape elongated in the width direction. Each negative electrode 120 includes a negative electrode current collector foil 122 and a negative electrode active material layer 124 provided on both surfaces of the negative electrode current collector foil 122. As shown in FIG. 2, the negative electrode current collector foil 122 has a negative electrode tab 122n (see FIG. 2) in which the negative electrode active material layer 124 is not provided. The negative electrode tab 122n protrudes toward the other side in the width direction.

The separator 130 insulates the positive electrode 110 from the negative electrode 120. The separator 130 is made of an insulating material, and has minute voids that allow penetration of ions. As shown in FIG. 3, the separator 130 is folded.

The separator 130 has a rectangular shape before being folded. The separator 130 is folded between the electrodes 110 and 120. The separator 130 includes a plurality of intervening portions 132a, a plurality of upper folded portions 132b, a plurality of lower folded portions 132c, and an outermost covering portion 132d.

Each intervening portion 132a is interposed between a pair of electrodes 110 and 120 adjacent to each other in one direction. That is, each intervening portion 132a has a function of insulating the positive electrode 110 and the negative electrode 120. Each intervening portion 132a is configured by a rectangular region.

The upper folded portions 132b connect an upper end portion of one of the plurality of intervening portions 132a and an upper end portion of the intervening portion 132a adjacent to the one intervening portion 132a on one side of the plurality of intervening portions 132a in one direction. In the present embodiment, the upper folded portion 132b is disposed above the positive electrode 110.

Each lower folded portion 132c connects a lower end portion of the one intervening portion of the plurality of intervening portions 132a and a lower end portion of the intervening portion 132a adjacent to the one intervening portion on the other side in one direction of the plurality of intervening portions 132a. In the present embodiment, the lower folded portion 132c is disposed below the negative electrode 120. In other words, the negative electrode 120 is disposed on the lower folded portion 132c.

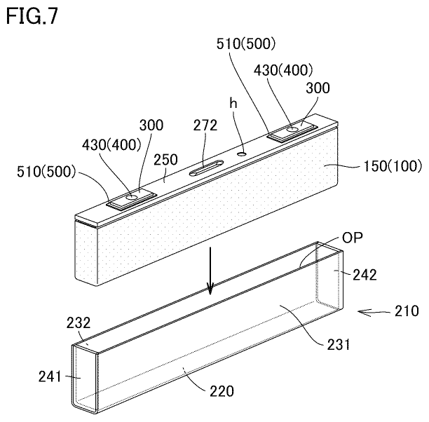

The outermost covering portions 132d collectively cover the upper folded portions 132b and the lower folded portions 132c. More specifically, the outermost covering portion 132d collectively covers all of the electrodes 110 and 120, all of the intervening portions 132a, all of the upper folded portions 132b, and all of the lower folded portions 132c while winding around a central axis parallel to the width direction. The terminal end 132e of the outermost covering portion 132d is set so as not to overlap the positive electrode active material layer 114 and the negative electrode active material layer 124 in one direction. In the present embodiment, the terminal end 132e of the outermost covering portion 132d is provided below each of the electrodes 110 and 120. The peripheral surfaces and bottom surfaces of the plurality of electrodes 110 and 120 and the separator 130 are covered with an insulating film 150 (see FIG. 7, which will be described later, and not shown in FIGS. 2 and 3).

As shown in FIGS. 1 and 2, the battery case 200 houses the electrode assembly 100. The battery case 200 contains an electrolyte solution (not shown). The battery case 200 is sealed. The battery case 200 is made of a metal such as aluminum or an aluminum alloy.

The battery case 200 has a bottomed tubular outer shape. The battery case 200 includes a case body 210 and a lid portion 250. The case body includes a bottom portion 220, a first side surface portion 231, a second side surface portion 232, a first end surface portion 241, and a second end surface portion 242.

The bottom portion 220 has a planar outer shape. The bottom portion 220 extends in a plane direction orthogonal to the height direction H. When viewed from the height direction H, the bottom portion 220 has a substantially rectangular outer shape.

The bottom portion 220 includes a pair of long side portions 221 and a pair of short side portions 222. The long side portion 221 extends along the width direction W. The short side portion 222 extends along the thickness direction T. The length of each of the pair of long side portions 221 is longer than the length of each of the pair of short side portions 222.

The first side surface portion 231 rises from the bottom portion 220. The direction in which the first side surface portion 231 rises is the height direction H. Specifically, the first side surface portion 231 rises from one of the pair of long side portions 221. In this embodiment, the first side surface portion 231 and the bottom portion 220 are integrally molded without being welded.

The second side surface portion 232 rises from the bottom portion 220 while facing the first side surface portion 231. Therefore, the direction in which the second side surface portion 232 rises is also the height direction H. Specifically, the second side surface portion 232 rises from the other of the pair of long side portions 221. In this embodiment, the second side surface portion 232 and the bottom portion 220 are integrally molded without being welded.

The first end surface portion 241 is joined to one of the pair of short side portions 222 of the bottom portion 220 by welding. The first end surface portion 241 extends in the height direction H from one of the pair of short side portions 222. The first end surface portion 241 is joined to both the first side surface portion 231 and the second side surface portion 232 by welding.

The second end surface portion 242 is joined to the other of the pair of short side portions 222 of the bottom portion 220 by welding. The first end surface portion 241 extends in the height direction H from the other of the pair of short side portions 222. The first end surface portion 241 is joined to both the first side surface portion 231 and the second side surface portion 232 by welding.

The case body 210 has an opening OP. The opening OP is located opposite the bottom portion 220. The opening OP is formed by an end edge of each of the first side surface portion 231, the second side surface portion 232, the first end surface portion 241, and the second end surface portion 242 located on the side opposite to the bottom portion 220 side.

The lid portion 250 closes the opening OP. The lid portion 250 is connected to the opening OP by welding or the like. The lid portion 250 is formed in a flat plate shape.

The lid portion 250 includes a pressure release valve 272 and a sealing member 274. The pressure release valve 272 is formed at the center of the lid portion 250. The pressure release valve 272 is formed to break when the internal pressure of the battery case 200 becomes equal to or higher than a predetermined pressure. When the pressure release valve 272 breaks, the gas in the battery case 200 is released to the outside of the battery case 200 through the pressure release valve 272, so that the internal pressure of the battery case 200 decreases.

The sealing member 274 seals the liquid injection port h formed in the lid portion 250. The liquid injection port h is a through hole for injecting the electrolyte solution into the battery case 200 in the manufacturing process of the power storage cell 1. After the electrolyte solution is injected into the battery case 200 through the liquid injection port h, the liquid injection port h is sealed with the sealing member 274.

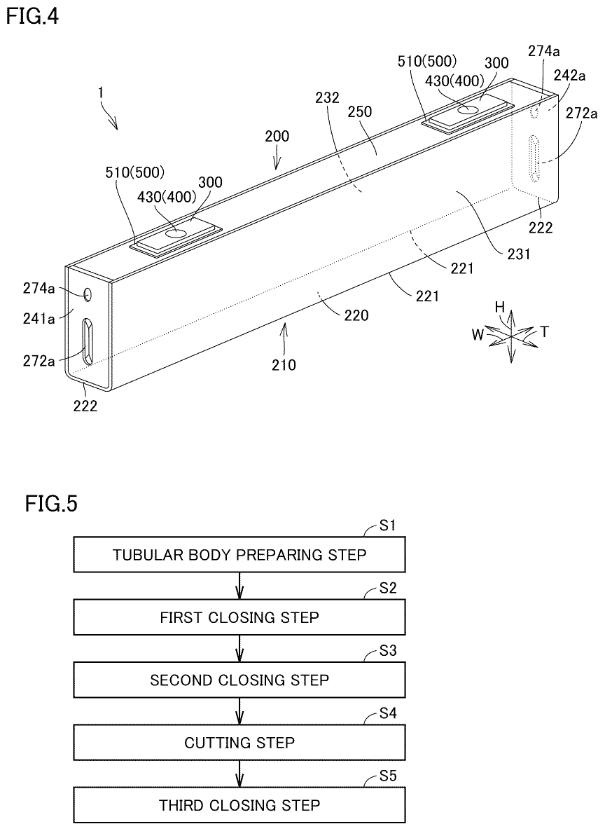

The pressure release valve 272 and the sealing member 274 may be disposed at different locations from the lid portion 250. FIG. 4 is a perspective view showing a power storage cell according to a modified example of the present disclosure. As shown in FIG. 4, the first end surface portion 241a may include a pressure release valve 272a and a sealing member 274a. The second end surface portion 242a may include a pressure release valve 272a and a sealing member 274a.

As shown in FIGS. 1 and 2, the pair of external terminals 300 is fixed to the battery case 200. One of the pair of external terminals 300 is a positive electrode external terminal and the other is a negative electrode external terminal. Each external terminal 300 is fixed to the upper surface of the lid portion 250 via an upper insulating portion 510 described later. Each external terminal 300 is made of a metal such as aluminum.

The pair of connecting members 400 connects the plurality of electrode tabs 112p and 122n to the external terminal 300. One of the connecting members 400 connects the plurality of positive electrode tabs 112p and the positive electrode external terminal 300, and the other connecting member 400 connects the plurality of negative electrode tabs 122n and the negative electrode external terminal 300. Since each of the pair of connecting members 400 has substantially the same structure, one of the connecting members 400 will be described below.

The connecting member 400 includes a current collector tab 410, a sub-tab 420, and a connecting pin 430.

The current collector tab 410 has a lateral portion 412 and an upper portion 414. The lateral portion 412 is positioned on the lateral side of the electrode assembly 100 in the width direction. The upper portion 414 is positioned above the electrode assembly 100. The upper portion 414 extends inward in the width direction from the upper end of the lateral portion 412.

The sub-tab 420 connects the plurality of positive electrode tabs 112p to the current collector tab 410. One end 422 of the sub-tab 420 is connected to the plurality of positive electrode tabs 112p by welding or the like, and the other end 424 of the sub-tab 420 is connected to the lateral portion 412 of the current collector tab 410 by welding or the like.

The connecting pin 430 connects the current collector tab 410 and the external terminal 300. The connecting pin 430 connects the upper portion 414 and the external terminal 300. Specifically, the lower end portion of the connecting pin 430 is connected to the upper portion 414 by welding or the like in a state of being inserted into a through hole provided in the upper portion 414, and the upper end portion of the connecting pin 430 is connected to the external terminal 300 by welding, caulking or the like in a state of being inserted into a through hole provided in the external terminal 300.

The insulating member 500 insulates the battery case 200 from the connecting member 400. The insulating member 500 includes an upper insulating portion 510, a lower insulating portion 520, an insulating tube 530, and an insulating plate 540.

The upper insulating portion 510 is fixed to the upper surface of the lid portion 250. The upper insulating portion 510 is disposed between the lid portion 250 and the external terminal 300. The upper insulating portion 510 is provided with an insertion hole through which the connecting pin 430 is inserted.

The lower insulating portion 520 is fixed to the lower surface of the lid portion 250. The lower insulating portion 520 is disposed between the lid portion 250 and the lower portion of the upper portion 414 and the connecting pin 430. The lower insulating portion 520 is provided with an insertion hole through which the connecting pin 430 is inserted.

The insulating tube 530 is disposed between the connecting pin 430 and the lid portion 250. The insulating tube 530 is formed in a tubular shape and surrounds the connecting pin 430.

The insulating plate 540 is fixed to the lower surface of the upper portion 414. The insulating plate 540 is disposed above the electrode assembly 100. A through hole is formed in a portion of the insulating plate 540 located below the pressure release valve 272 and a portion of the insulating plate 540 located below the liquid injection port h.

It should be noted that the pair of connecting member 400 of the one of the connecting member 400 (For example, the connecting member 400 electrically connected to the positive electrode tab 112p.), and a battery case 200 and the insulation between the insulating member 500, the upper insulating portion 510 is not necessarily included. In this case, the external terminal 300 may be in direct contact with the battery case 200, or another conductive member may be disposed between the external terminal 300 and the battery case 200 instead of the upper insulating portion 510.

### [Method of Manufacturing Battery Case]

Next, a method of manufacturing a battery case according to an embodiment of the present disclosure will be described. FIG. 5 is a flowchart showing a method of manufacturing a battery case according to an embodiment of the present disclosure. As shown in FIG. 5, the manufacturing method of the battery case according to the embodiment of the present disclosure includes a tubular body preparing step S1, a first closing step S2, a second closing step S3, a cutting step S4, and a third closing step S5 in this order. However, the order of the first closing step S2 and the second closing step S3 is not limited to the above. The second closing step S3 may be performed before the first closing step S2, or may be performed simultaneously with the first closing step S2.

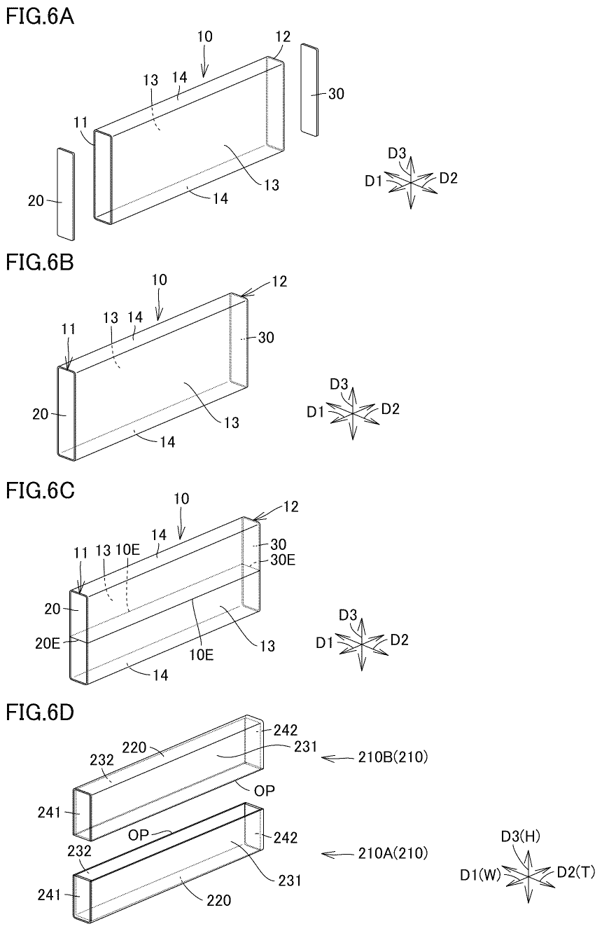

FIGS. 6A to 6D are schematic views showing a state from the tubular body preparing step to the cutting step in time series.

As shown in FIG. 6A, in the tubular body preparing step S1, the tubular body 10 is prepared. The tubular body 10 has a first opening end 11 and a second opening end 12 at opposite sides respectively in the first direction D1. Specifically, the tubular body 10 has a substantially rectangular tubular outer shape. That is, the first opening end 11 and the second opening end 12 have a substantially rectangular annular outer shape when viewed from the first direction D1.

The tubular body 10 includes a pair of first peripheral wall portions 13 and a pair of second peripheral wall portions 14. The pair of first peripheral wall portions 13 are opposed to each other in the second direction D2. The second direction D2 is a direction orthogonal to the first direction D1. The first peripheral wall portion 13 has a rectangular outer shape in which the first direction D1 is the longitudinal direction when viewed from the second direction D2.

The pair of second peripheral wall portions 14 are opposed to each other in the third direction D3. The third direction D3 is a direction orthogonal to both the first direction D1 and the second direction D2. The second peripheral wall portion 14 has a rectangular outer shape whose longitudinal direction is the first direction D1 when viewed from the third direction. The dimension of the second peripheral wall portion 14 in the second direction D2 is shorter than the dimension of the first peripheral wall portion 13 in the third direction D3. The dimension of the first peripheral wall portion 13 in the third direction D3 is shorter than the dimension of the tubular body 10 in the first direction D1 (the dimension of the first peripheral wall portion 13 and the second peripheral wall portion 14 in the first direction D1).

The tubular body 10 is made of a metal such as aluminum or an aluminum alloy. In the present embodiment, the tubular body 10 is prepared by extrusion molding. As a specific method of extrusion molding, a conventionally known method can be adopted.

As shown in FIGS. 6A and 6B, in the first closing step S2, the first opening end 11 is closed with the first plate member 20. Specifically, the first plate member 20 is joined to the first opening end 11 by welding such as laser welding. The first plate member 20 has a substantially rectangular outer shape when viewed from the first direction D1.

In the second closing step S3, the second opening end 12 is closed with the second plate member 30. Specifically, the second plate member 30 is joined to the second opening end 12 by welding such as laser welding. The second plate member 30 has a substantially rectangular outer shape when viewed from the first direction D1.

The first plate member 20 and the second plate member 30 are made of a metal such as aluminum or an aluminum alloy. The first plate member 20 and the second plate member 30 are preferably formed of the same material as the material forming the tubular body 10.

As shown in FIGS. 6B to 6D, in the cutting step S4, the tubular body 10, the first plate member 20, and the second plate member 30 are cut along a plane parallel to the first direction D1 in a state where the first opening end 11 is closed with the first plate member 20 and the second opening end 12 is closed with the second plate member 30. Specifically, the plane is a plane parallel to both the first direction D1 and the second direction D2.

By the above cutting, the tubular body 10 is divided into two in the third direction D3. Specifically, each of the pair of first peripheral wall portions 13 is divided into two in the third direction D3. A pair of cut edges 10E is formed in each of the two separate tubular bodies 10. The pair of cut edges 10E extend in the first direction D1.

By the above cutting, the first plate member 20 is divided into two in the third direction D3. Specifically, cut edges 20E are formed in the two separate first plate members 20. The cut edges 20E extend in the second direction D2.

By the above cutting, the second plate member 30 is divided into two in the third direction D3. Specifically, cut edges 30E are formed in the two separate second plate members 30. The cut edges 30E extend in the second direction D2.

Therefore, in the cutting step S4, the case body 210 having the opening OP formed by the cut edges 10E, 20E, and 30E of the tubular body 10, the first plate member 20, and the second plate member 30 is obtained. Specifically, by the above cutting, one of the pair of second peripheral wall portions 14 becomes the bottom portion 220. A part of each of the pair of first peripheral wall portions 13 forms a first side surface portion 231 and a second side surface portion 232. A part of the first plate member 20 becomes the first end surface portion 241. A part of the second plate member 30 becomes the second end surface portion 242.

Further, in the present embodiment, as shown in FIGS. 6C and 6D, a plurality of case bodies 210 can be obtained including a first case body 210A formed by respective parts of the cut tubular body 10, the cut first plate member 20, and the cut second plate member 30, and a second case body 210B formed by other respective parts of the cut tubular body 10, the cut first plate member 20, and the cut second plate member 30.

FIG. 7 is a schematic view showing a third closing step. As shown in FIG. 7, in the third closing step S5, the opening OP of the case body 210 is closed with the lid portion 250. Specifically, the lid portion 250 is joined to the opening OP by welding such as laser welding.

The electrode assembly 100, the external terminal 300, the connecting member 400, and the insulating member 500 are previously assembled to the lid portion 250. The lid portion 250 closes the opening OP, and the electrode assembly 100 and the like are accommodated in the case body 210. At this time, the sealing member 274 is not provided at the liquid injection port h.

After the opening OP is closed with the lid portion 250, the electrolyte solution is injected from the liquid injection port h. After the electrolyte solution is injected, the liquid injection port h is sealed with the sealing member 274 (see FIG. 1). Thus, the battery case 200 according to the present embodiment is manufactured. In addition, the battery case 200 and the power storage cell 1 are manufactured.

As described above, the method of manufacturing a battery case according to one embodiment of the present disclosure is a method of manufacturing the battery case 200 which is capable of accommodating the electrode assembly 100 and which includes: the bottomed tubular case body 210 having the bottom portion 220 and the opening OP located opposite to the bottom portion 220; and the lid portion 250 closing the opening OP. The manufacturing method includes: preparing the tubular body 10 having the first opening end 11 and the second opening end 12 that are respectively located at opposite sides in the first direction D1 (S1); closing the first opening end 11 with the first plate member 20 (S2); closing the second opening end 12 with the second plate member 30 (S3); in a state where the first opening end 11 is closed with the first plate member 20 and the second opening end 12 is closed with the second plate member 30, cutting the tubular body 10, the first plate member 20, and the second plate member 30 along a plane parallel to the first direction D1, to obtain the case body 210 having the opening OP formed by respective cut edges 10E, 20E, and 30E of the tubular body 10, the first plate member 20, and the second plate member 30 (S4); and closing the opening OP of the case body 210 with the lid portion 250 (S5).

According to the above configuration, the tubular body 10 having the first opening end 11 and the second opening end 12 on the opposite sides can be prepared without depending on drawing. At this time, it is also possible to prepare the tubular body 10 which is relatively long in the first direction D1. By cutting the tubular body 10, the first plate member 20, and the second plate member 30 along the plane parallel to the first direction D1, the case body 210 having the relatively long opening OP in the first direction D1 (width direction W) can be easily obtained. That is, according to the manufacturing method of the battery case of the present embodiment, the degree of freedom of the size of the opening OP formed in the case body 210 in the first direction D1 (width direction W) can be increased.

In the manufacturing method of the battery case according to the embodiment of the present disclosure, the tubular body 10 is prepared by extrusion molding.

According to the above configuration, by molding the tubular body 10 by extrusion molding, it becomes easier to prepare the tubular body 10 which is relatively long in the first direction D1.

Further, in the method of manufacturing a battery case according to the embodiment of the present disclosure, a plurality of case bodies 210 are obtained, including a first case body 210A made up of respective parts of the cut tubular body 10, the cut first plate member 20, and the cut second plate member 30, and a second case body 210B made up of other respective parts of the cut tubular body 10, the cut first plate member 20, and the cut second plate member 30.

According to the above-described process, it is possible to suppress excess members in the cutting step S4 and improve the yield of the case body 210 with respect to the tubular body 10, the first plate member 20, and the second plate member 30.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A method of manufacturing a battery case capable of accommodating an electrode assembly, and comprising: a case body in a bottomed tubular shape having a bottom portion and an opening located opposite to the bottom portion; and a lid portion closing the opening, the method comprising:
preparing a tubular body having a first opening end and a second opening end that are respectively located at opposite sides in one direction;
closing the first opening end with a first plate member;
closing the second opening end with a second plate member;
in a state where the first opening end is closed with the first plate member and the second opening end is closed with the second plate member, cutting the tubular body, the first plate member, and the second plate member along a plane parallel to the one direction, to obtain the case body having the opening formed by respective cut edges of the tubular body, the first plate member, and the second plate member; and
sealing the opening of the case body with the lid portion.

2. The method of manufacturing a battery case according to claim 1, wherein the tubular body is prepared by extrusion molding.

3. The method of manufacturing a battery case according to claim 1, wherein a plurality of the case bodies are obtained, including a first case body made up of respective parts of the cut tubular body, the cut first plate member, and the cut second plate member, and a second case body made up of other respective parts of the cut tubular body, the cut first plate member, and the cut second plate member.

4. The method of manufacturing a battery case according to claim 2, wherein a plurality of the case bodies are obtained, including a first case body made up of respective parts of the cut tubular body, the cut first plate member, and the cut second plate member, and a second case body made up of other respective parts of the cut tubular body, the cut first plate member, and the cut second plate member.
